(19) United States
(12) Patent Application Publication
(10) Pub. No.: US 2018/0307108 A1
(43) Pub. Date: Oct. 25, 2018

(54) LIQUID CRYSTAL DISPLAY PANEL, LIQUID CRYSTAL DISPLAY APPARATUS AND OPERATING METHOD THEREOF

(71) Applicant: BOE TECHNOLOGY GROUP CO., LTD., Beijing (CN)

(72) Inventors: Liangliang Jiang, Beijing (CN); Wenhao Tang, Beijing (CN); Lei Guo, Beijing (CN)

(73) Assignees: BOE TECHNOLOGY GROUP CO., LTD., Beijing (CN); Hefei Xinsheng Optoelectronics Technology Co., Ltd., Hefei, Anhui (CN)

(21) Appl. No.: 15/768,224

(22) PCT Filed: Apr. 20, 2017
(86) PCT No.: PCT/CN2017/081236

§ 371 Date: Apr. 13, 2018

(51) Int. Cl. G02F 1/1362; G02F 1/1337; G02F 1/133

(52) U.S. Cl. CPC G02F 1/136286; G02F 1/13306; G02F 1/1337

(57) ABSTRACT

The present application discloses a liquid crystal display panel including an array substrate having an array of a plurality of subpixels along a first direction and a second direction; a counter substrate facing the array substrate; and a liquid crystal layer between the array substrate and the counter substrate. The liquid crystal layer includes a plurality of elongated regions of differing thickness successively along the second direction, each of the plurality of elongated regions substantially along the first direction. The plurality of elongated regions includes a plurality of first regions and a plurality of second regions, the plurality of elongated regions alternating between one of the plurality of first regions and one of the plurality of second regions. The liquid crystal layer in each of the plurality of first regions has a thickness greater than that in each of the plurality of second regions by approximately 10% to approximately 50%.

### TECHNICAL FIELD

The present invention relates to display technology, more particularly, to a liquid crystal display panel, a liquid crystal display apparatus and a method of operating the liquid crystal display panel.

### BACKGROUND

Fringe field driven liquid crystal display panels such as an in-plane switching liquid crystal display panel and a fringe field switching liquid crystal display panel have the advantages of a wide viewing angle, high transmittance, and fast response. In some fringe field driven liquid crystal display panels, the subpixels have a two-domain symmetrical subpixel structure and the pixel electrode has a plurality of slits. To align liquid crystal molecules in a liquid crystal layer of the liquid crystal display panels, an alignment layer is rubbed along a rubbing direction. The liquid crystal molecules are pre-aligned based on the rubbing direction. An electric field (e.g., a fringe electric field) changes an alignment direction of the liquid crystal molecules in a liquid crystal layer. Light transmittance of the liquid crystal layer is adjusted when the alignment direction of the liquid crystal molecules changes. The angle between the alignment direction and a direction along which the plurality of slits of the pixel electrode is arranged is denoted as a twist angle. Light transmittance and driving voltage for achieving the light transmittance are two important parameters of the liquid crystal display panels.

### SUMMARY

In one aspect, the present invention provides a liquid crystal display panel comprising an array substrate comprising an array of a plurality of subpixels along a first direction and a second direction; a counter substrate facing the array substrate; and a liquid crystal layer between the array substrate and the counter substrate; wherein the liquid crystal layer comprises a plurality of elongated regions of differing thickness successively along the second direction, each of the plurality of elongated regions substantially along the first direction; the plurality of elongated regions comprise a plurality of first regions and a plurality of second regions, the plurality of elongated regions alternating between one of the plurality of first regions and one of the plurality of second regions; and the liquid crystal layer in each of the plurality of first regions has a thickness greater than that in each of the plurality of second regions by approximately 10% to approximately 50%.

Optionally, light transmittance of the liquid crystal layer in each of the plurality of first regions is higher than that of the liquid crystal layer in each of the plurality of second regions.

Optionally, the liquid crystal layer in each of the plurality of first regions has a first thickness, and the liquid crystal layer in each of the plurality of second regions has a second thickness, the first thickness being greater than the second thickness.

Optionally, a width of each of the plurality of first regions and the plurality of second regions along the second direction is substantially the same as a width along the second direction of each of the plurality of subpixels.

Optionally, the liquid crystal display panel further comprises a plurality of data lines and a plurality of gate lines crossing over each other thereby defining the array of a plurality of subpixels along the first direction and the second direction; wherein the plurality of data lines are substantially along the second direction and the plurality of gate lines are substantially along the first direction; the plurality of data lines comprises a plurality of first data lines and a plurality of second data lines; the liquid crystal display panel comprises one of the plurality of first data lines and one of the plurality of second data lines between adjacent columns of subpixels along the second direction; the plurality of first data lines are configured to provide a plurality of data signals respectively to a plurality of subpixels in the plurality of first regions; and the plurality of second data lines are configured to provide a plurality of data signals respectively to a plurality of subpixels in the plurality of second regions.

Optionally, the liquid crystal display panel further comprises a plurality of data lines and a plurality of gate lines crossing over each other thereby defining the array of a plurality of subpixels along the first direction and the second direction; wherein the plurality of data lines are substantially along the first direction and the plurality of gate lines are substantially along the second direction; the plurality of gate lines comprises a plurality of first gate lines and a plurality of second gate lines; the liquid crystal display panel comprises one of the plurality of first gate lines and one of the plurality of second gate lines between adjacent rows of subpixels along the first direction; the plurality of first gate lines are configured to provide a plurality of gate scanning signals respectively to a plurality of subpixels in the plurality of first regions; and the plurality of second gate lines are configured to provide a plurality of gate scanning signals respectively to a plurality of subpixels in the plurality of second regions.

Optionally, the counter substrate comprises a base substrate and a passivation layer on a side of the base substrate proximal to the liquid crystal layer; the passivation layer has a third thickness in the plurality of first regions and a fourth thickness in the plurality of second regions; and the third thickness is less than the fourth thickness.

Optionally, a difference between the first thickness and the second thickness is in a range of approximately 0.2 μm to approximately 0.4 μm.

Optionally, the liquid crystal display panel is a fringe field driven liquid crystal display panel.

In another aspect, the present invention provides a liquid crystal display apparatus comprising a liquid crystal display panel described herein.

In another aspect, the present invention provides a method of operating a liquid crystal display panel described herein, comprising turning off a plurality of subpixels in regions corresponding to the plurality of first regions; and turning on a plurality of subpixels in regions corresponding to the plurality of second regions to emit light in each frame of image for image display.

Optionally, the plurality of data lines are substantially along the second direction and the plurality of gate lines are substantially along the first direction; the plurality of data lines comprises a plurality of first data lines and a plurality of second data lines; the liquid crystal display panel comprises one of the plurality of first data lines and one of the plurality of second data lines between adjacent columns of subpixels along the second direction; and the method further comprises providing a plurality of data signals respectively to a plurality of subpixels in the plurality of second regions through the plurality of second data lines; and turning off a plurality of subpixels in the plurality of first regions.

Optionally, the plurality of data lines are substantially along the first direction and the plurality of gate lines are substantially along the second direction; the plurality of gate lines comprises a plurality of first gate lines and a plurality of second gate lines; the liquid crystal display panel comprises one of the plurality of first gate lines and one of the plurality of second gate lines between adjacent rows of subpixels along the first direction; and the method further comprises providing a plurality of gate scanning signals respectively to a plurality of subpixels in the plurality of second regions through the plurality of second gate lines; and turning off a plurality of subpixels in the plurality of first regions.

In another aspect, the present invention provides a method of operating a liquid crystal display panel described herein, comprising turning off a plurality of subpixels in regions corresponding to the plurality of second regions; and turning on a plurality of subpixels in regions corresponding to the plurality of first regions to emit light in each frame of image for image display.

Optionally, the plurality of data lines are substantially along the second direction and the plurality of gate lines are substantially along the first direction; the plurality of data lines comprises a plurality of first data lines and a plurality of second data lines; the liquid crystal display panel comprises one of the plurality of first data lines and one of the plurality of second data lines between adjacent columns of subpixels along the second direction; and the method further comprises providing a plurality of data signals respectively to a plurality of subpixels in the plurality of first regions through the plurality of first data lines; and turning off a plurality of subpixels in the plurality of second regions.

Optionally, the plurality of data lines are substantially along the first direction and the plurality of gate lines are substantially along the second direction; the plurality of gate lines comprises a plurality of first gate lines and a plurality of second gate lines; the liquid crystal display panel comprises one of the plurality of first gate lines and one of the plurality of second gate lines between adjacent rows of subpixels along the first direction; and the method further comprises providing a plurality of gate scanning signals respectively to a plurality of subpixels in the plurality of first regions through the plurality of first gate lines; and turning off a plurality of subpixels in the plurality of second regions.

In another aspect, the present invention provides a method of operating a liquid crystal display panel described herein, comprising turning on both a plurality of subpixels in regions corresponding to the plurality of first regions and a plurality of subpixels in regions corresponding to the plurality of second regions to emit light in each frame of image for image display.

Optionally, the plurality of data lines are substantially along the second direction and the plurality of gate lines are substantially along the first direction; the plurality of data lines comprises a plurality of first data lines and a plurality of second data lines; the liquid crystal display panel comprises one of the plurality of first data lines and one of the plurality of second data lines between adjacent columns of subpixels along the second direction; and the method further comprises providing a plurality of data signals respectively to a plurality of subpixels in the plurality of first regions through the plurality of first data lines, and providing a plurality of data signals respectively to a plurality of subpixels in the plurality of second regions through the plurality of second data lines.

Optionally, the plurality of data lines are substantially along the first direction and the plurality of gate lines are substantially along the second direction; the plurality of gate lines comprises a plurality of first gate lines and a plurality of second gate lines; the liquid crystal display panel comprises one of the plurality of first gate lines and one of the plurality of second gate lines between adjacent rows of subpixels along the first direction; the method further comprises providing a plurality of gate scanning signals respectively to a plurality of subpixels in the plurality of first regions through the plurality of first gate lines, and providing a plurality of gate scanning signals respectively to a plurality of subpixels in the plurality of second regions through the plurality of second gate lines.

In another aspect, the present invention provides a method of operating a liquid crystal display panel described herein, comprising turning on the plurality of subpixels in regions corresponding to the plurality of first regions for a first time interval in each frame of image; and turning on the plurality of subpixels in regions corresponding to the plurality of second regions for a second time interval in each frame of image, the second time interval being different from the first time interval.

### BRIEF DESCRIPTION OF THE FIGURES

The following drawings are merely examples for illustrative purposes according to various disclosed embodiments and are not intended to limit the scope of the present invention.

FIG. 1 is a schematic diagram illustrating the structure of a liquid crystal display panel in some embodiments according to the present disclosure.

FIG. 2 is a cross-sectional view of the liquid crystal display panel along A-A′ line in FIG. 1.

FIG. 3 is a schematic diagram illustrating the structure of a liquid crystal display panel in some embodiments according to the present disclosure.

FIG. 4 is a schematic diagram illustrating the structure of a liquid crystal display panel in some embodiments according to the present disclosure.

FIG. 5 is a schematic diagram illustrating the structure of a liquid crystal display panel in some embodiments according to the present disclosure.

### DETAILED DESCRIPTION

The disclosure will now be described more specifically with reference to the following embodiments. It is to be noted that the following descriptions of some embodiments are presented herein for purpose of illustration and description only. It is not intended to be exhaustive or to be limited to the precise form disclosed.

In fringe field driven liquid crystal display panels, transmittance of a liquid crystal layer is cell gap-dependent. The term “cell gap” refers to a thickness of the liquid crystal layer between an array substrate and a counter substrate, or a distance between the array substrate and the counter substrate. For example, liquid crystal molecules in a liquid crystal layer having a smaller cell gap are less twisted as compared to those in a liquid crystal layer having a larger cell gap. Consequently, as the cell gap decreases, the transmittance also decreases; and as the cell gap increases, the transmittance also increases. Moreover, it was discovered in the present disclosure that, as the cell gap increases, a driving voltage V, and response time of the liquid crystal layer also increase. As the driving voltage increases, power consumption of the liquid crystal display panel also increases. In summary, a relatively larger cell gap corresponds to higher transmittance, a higher driving voltage, and higher power consumption; a relatively smaller cell gap corresponds to lower transmittance, a lower driving voltage, and lower power consumption.

In conventional liquid crystal display panels, the cell gaps are consistent throughout all subpixels of the entire display panel. To achieve a high brightness level, the conventional liquid crystal display panels typically have a relatively large cell gap in order to increase the transmittance of the liquid crystal layer, leading to higher power consumption. To achieve low power consumption, the conventional liquid crystal display panels typically have a relatively small cell gap in order to decrease the driving voltage, leading to lower transmittance of the liquid crystal layer and a lower brightness level of the display panel. The conventional liquid crystal display panels lack the flexibility to adjust display based on various user needs and working environments.

Accordingly, the present disclosure provides, inter alia, a liquid crystal display panel and a liquid crystal display apparatus that substantially obviate one or more of the problems due to limitations and disadvantages of the related art. In one aspect, the present disclosure provides a liquid crystal display panel. In some embodiments, the liquid crystal display panel includes an array substrate having an array of a plurality of subpixels along a first direction and a second direction; a counter substrate facing the array substrate; and a liquid crystal layer between the array substrate and the counter substrate. Optionally, the liquid crystal layer includes a plurality of elongated regions of differing thickness successively along the second direction, each of the plurality of elongated regions substantially along the first direction. Optionally, the plurality of elongated regions include a plurality of first regions and a plurality of second regions, the plurality of elongated regions alternating between one of the plurality of first regions and one of the plurality of second regions. Optionally, the liquid crystal layer in each of the plurality of first regions has a thickness greater than that in each of the plurality of second regions.

The present liquid crystal display panel has enhanced flexibility to be suited for various user needs and working environments. For example, when lower power consumption and a longer battery life are desired (e.g., the user is traveling), the present liquid crystal display panel can be adjusted to a display mode corresponding to a low brightness level or a medium brightness level. When better user viewing experience and higher display quality are in demand, the present liquid crystal display panel can be adjusted to a display mode corresponding to a high brightness level.

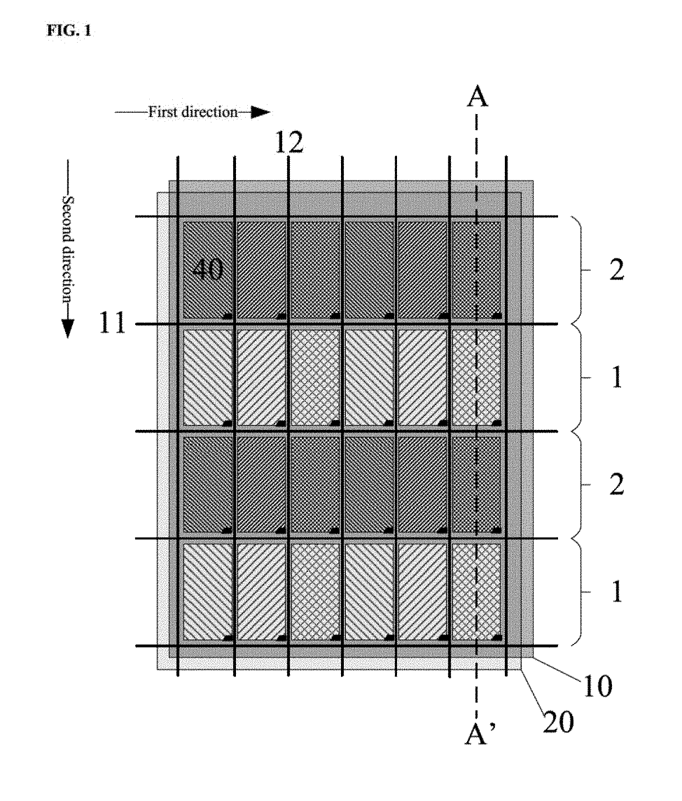

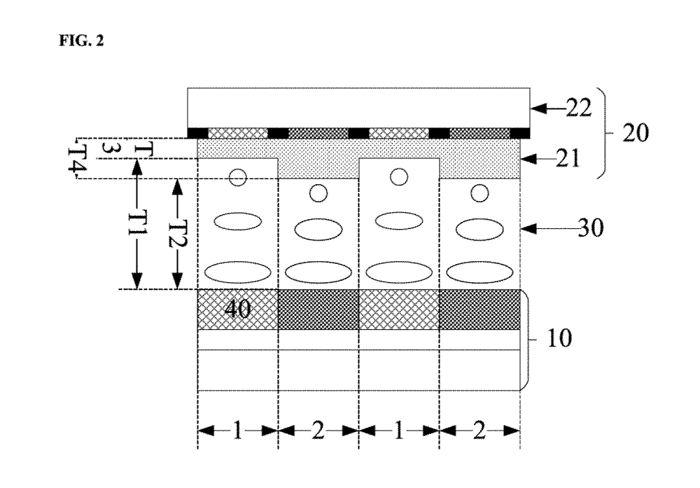

FIG. 1 is a schematic diagram illustrating the structure of a liquid crystal display panel in some embodiments according to the present disclosure. FIG. 2 is a cross-sectional view of the liquid crystal display panel along A-A′ line in FIG. 1. Referring to FIG. 1 and FIG. 2, the liquid crystal display panel in some embodiments includes an array substrate 10, a counter substrate 20 facing the array substrate 10, and a liquid crystal layer 30 between the array substrate 10 and the counter substrate 20. The array substrate 10 includes an array of a plurality of subpixels 40 along a first direction and a second direction. The liquid crystal layer 30 includes a plurality of elongated regions of differing thickness successively along the second direction. Each of the plurality of elongated regions extends substantially along the first direction. As shown in FIG. 1, the plurality of elongated regions includes a plurality of first regions 1 and a plurality of second regions 2. The plurality of elongated regions alternate between one of the plurality of first regions 1 and one of the plurality of second regions 2. Optionally, the liquid crystal layer 30 in each of the plurality of first regions 1 has a thickness greater than that in each of the plurality of second regions 2. Optionally, the liquid crystal layer 30 in each of the plurality of first regions 1 has a thickness greater than that in each of the plurality of second regions 2 by approximately 10% to approximately 50%. Optionally, the liquid crystal layer 30 in each of the plurality of first regions 1 has a thickness greater than that in each of the plurality of second regions 2 by approximately 20% to approximately 40%. Optionally, the liquid crystal layer 30 in each of the plurality of first regions 1 has a thickness greater than that in each of the plurality of second regions 2 by approximately 30%. Optionally, the plurality of elongated regions alternate between a first region having a first thickness and a second region having a second thickness. For example, the liquid crystal layer in each of the plurality of first regions has substantially a same first thickness T1 along a direction from the array substrate to the counter substrate, and the liquid crystal layer in each of the plurality of second regions has substantially a same second thickness T2 along a direction from the array substrate to the counter substrate. The first thickness T1 is greater than the second thickness T2.

In some embodiments, light transmittance of the liquid crystal layer in each of the plurality of first regions is higher than that of the liquid crystal layer in each of the plurality of second regions. Optionally, the liquid crystal layer in each of the plurality of first regions has substantially a same first light transmittance, and the liquid crystal layer in each of the plurality of second regions has substantially a same second light transmittance. The first light transmittance is greater than the second light transmittance.

In some embodiments, the liquid crystal display panel has a first normal distance between the array substrate 10 and the counter substrate 20 in each of the plurality of first regions 1 and a second normal distance between the array substrate 10 and the counter substrate 20 in each of the plurality of second regions, the first normal distance being greater than the second normal distance. Optionally, a difference between the first normal distance and the second normal distance being substantially the same as that between the first thickness T1 and the second thickness T2. Optionally, the first normal distance is substantially the same as the first thickness T1. Optionally, the second normal distance is substantially the same as the second thickness T2.

In some embodiments, the counter substrate includes a base substrate 22 and a passivation layer 21 on a side of the base substrate 22 proximal to the liquid crystal layer 30. Referring to FIG. 2, the passivation layer 21 in some embodiments has a third thickness T3 in the plurality of first regions 1 and a fourth thickness T4 in the plurality of second regions 2. Optionally, the third thickness T3 is less than the fourth thickness T4. Optionally, a difference between the third thickness T3 and the fourth thickness T4 is substantially the same as that between the first thickness T1 and the second thickness T2.

Optionally, a difference between the first thickness T1 and the second thickness T2 is in a range of approximately 0.2 μm to approximately 0.4 μm. Optionally, a difference between the first normal distance and the second normal distance is in a range of approximately 0.2 μm to approximately 0.4 μm. Optionally, a difference between the third thickness T3 and the fourth thickness T4 is in a range of approximately 0.2 μm to approximately 0.4 μm.

In some embodiments, a ratio between the first thickness T1 and the second thickness T2 is less than 2:1. Optionally, a ratio between the first thickness T1 and the second thickness T2 is in a range of approximately 1.1:1 to approximately 1.5:1. Optionally, a ratio between the first thickness T1 and the second thickness T2 is approximately 1.3:1. In some embodiments, a ratio between the first thickness T1 and the second thickness T2 is less than 2:1. Optionally, a ratio between the first thickness T1 and the second thickness T2 is in a range of approximately 1.1:1 to approximately 1.5:1. Optionally, a ratio between the first thickness T1 and the second thickness T2 is in a range of approximately 1.2:1 to approximately 1.4:1. Optionally, a ratio between the first thickness T1 and the second thickness T2 is approximately 1.3:1.

In some embodiments, the liquid crystal display panel further includes a pixel electrode layer and a common electrode layer. Optionally, the pixel electrode layer and the common electrode layer are both transmissive electrode layers, e.g., not reflective electrode layers. Optionally, the array substrate includes at least one of the pixel electrode layer and the common electrode layer, both of which are transmissive electrode layers. Optionally, the array substrate includes only one of the pixel electrode layer and the common electrode layer, which is a transmissive electrode layer. Optionally, the pixel electrode layer and the common electrode layer in the plurality of second regions 2 of the liquid crystal display panel are transmissive electrode layers, e.g., not reflective electrode layers. Transmissive electrode layers are made of transparent electrode material, e.g., indium tin oxide. Reflective electrode layers are made of non-transparent electrode material, e.g., a metal material.

In some embodiments, a longitudinal direction of each of the plurality of subpixels 40 is substantially parallel to the first direction, and a lateral direction of each of the plurality of subpixels 40 is substantially parallel to the second direction. In some embodiments and referring to FIG. 1, the longitudinal direction of each of the plurality of subpixels 40 is substantially parallel to the second direction, and the lateral direction of each of the plurality of subpixels 40 is substantially parallel to the first direction.

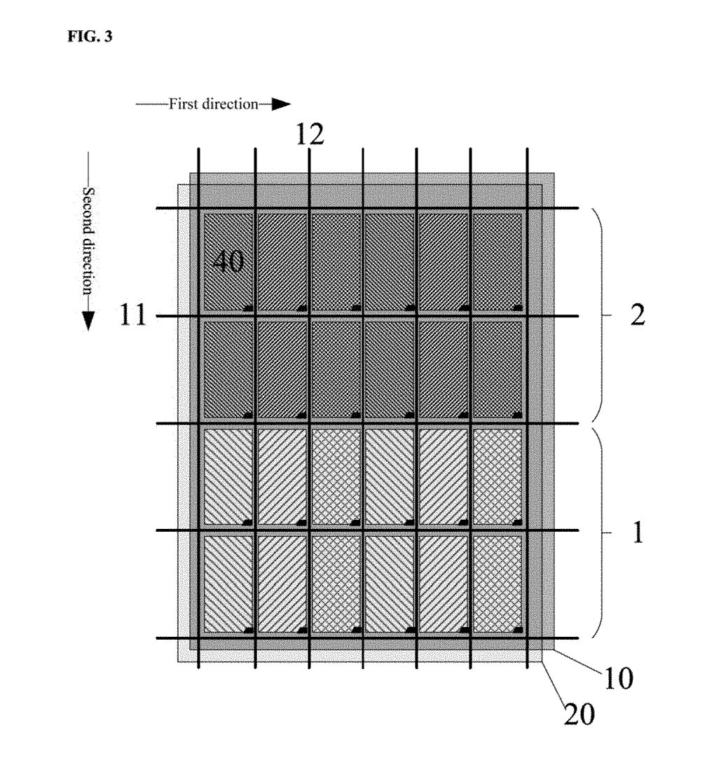

In some embodiments, a width of each of the plurality of first regions and the plurality of second regions along the second direction corresponds to a width of one or more subpixels along the second direction. Optionally, the width of each of the plurality of first regions corresponds to a width of a plurality of rows of subpixels along the second direction, and the width of each of the plurality of second regions corresponds to a width of a single row of subpixels along the second direction. Optionally, the width of each of the plurality of first regions corresponds to a width of a single row of subpixels along the second direction, and the width of each of the plurality of second regions corresponds to a width of a plurality of rows of subpixels along the second direction. Optionally, the width of each of the plurality of first regions and the plurality of second regions along the second direction is no greater than twice that of a width along the second direction of each of the plurality of subpixels. FIG. 3 is a schematic diagram illustrating the structure of a liquid crystal display panel in some embodiments according to the present disclosure. Referring to FIG. 3, the width of each of the plurality of first regions 1 and the plurality of second regions 2 along the second direction is substantially twice that of a width along the second direction of each of the plurality of subpixels 40. For example, each of the plurality of first regions 1 corresponds to two rows of subpixels 40 along the first direction, and each of the plurality of second regions 2 corresponds to two rows of subpixels 40 along the first direction.

In some embodiments, each of the plurality of first regions 1 corresponds to two rows of subpixels 40 along the first direction, and each of the plurality of second regions 2 corresponds to one row of subpixels 40 along the first direction. Optionally, a width of each of the plurality of first regions 1 along the second direction is substantially twice that of a width along the second direction of each of the plurality of subpixels 40; and a width of each of the plurality of second regions 2 along the second direction is substantially the same as a width along the second direction of each of the plurality of subpixels 40.

In some embodiments, each of the plurality of first regions 1 corresponds to one row of subpixels 40 along the first direction, and each of the plurality of second regions 2 corresponds to two rows of subpixels 40 along the first direction. Optionally, a width of each of the plurality of first regions 1 along the second direction is substantially the same as a width along the second direction of each of the plurality of subpixels 40; and a width of each of the plurality of second regions 2 along the second direction is substantially twice that of a width along the second direction of each of the plurality of subpixels 40.

In some embodiments, and referring to FIG. 1, each of the plurality of first regions 1 corresponds to one row of subpixels 40 along the first direction, and each of the plurality of second regions 2 corresponds to one row of subpixels 40 along the first direction. Optionally, a width of each of the plurality of first regions 1 and the plurality of second regions 2 along the second direction is substantially the same as a width along the second direction of each of the plurality of subpixels 40.

Referring to FIG. 1, the liquid crystal display panel in some embodiments further includes a plurality of first metal lines 11 and a plurality of second metal lines 12 crossing over each other thereby defining the array of a plurality of subpixels 40 along the first direction and the second direction. The plurality of first metal lines 11 extend substantially along the first direction, and the plurality of second metal lines 12 extend substantially along the second direction. Optionally, the plurality of first metal lines 11 are a plurality of data lines and the plurality of second metal lines 12 are a plurality of gate lines. Optionally, the plurality of data lines extend substantially along the first direction, and the plurality of gate lines extend substantially along the second direction. Optionally, the plurality of first metal lines 11 are a plurality of gate lines and the plurality of second metal lines 12 are a plurality of data lines. Optionally, the plurality of gate lines extend substantially along the first direction, and the plurality of data lines extend substantially along the second direction.

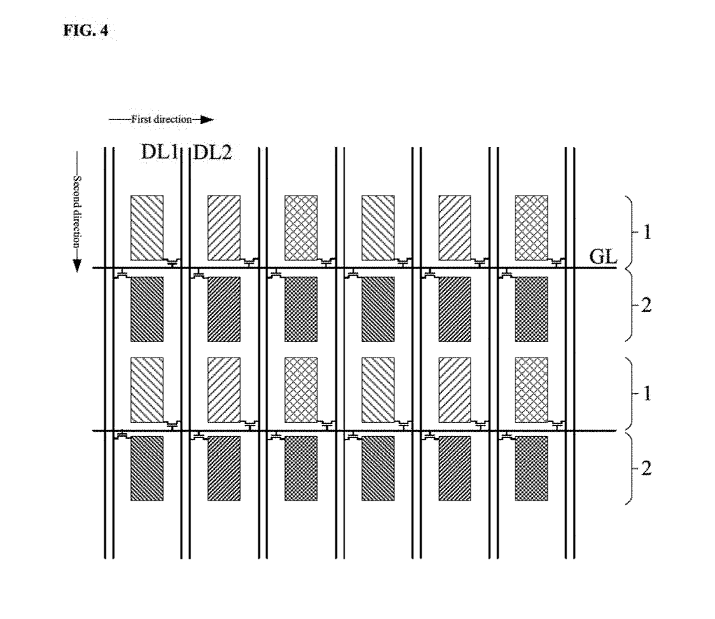

FIG. 4 is a schematic diagram illustrating the structure of a liquid crystal display panel in some embodiments according to the present disclosure. Referring to FIG. 4, the liquid crystal display panel in some embodiments includes a plurality of data lines extending substantially along the second direction and a plurality of gate lines GL extending substantially along the first direction. The plurality of data lines includes a plurality of first data lines DL1 and a plurality of second data lines DL2. Optionally, the plurality of data lines alternate, along the first direction, between one of the plurality of first data lines DL1 and one of the plurality of second data lines DL2. As shown in FIG. 4, between each pair of adjacent columns of subpixels along the first direction, the liquid crystal display panel includes one of the plurality of first data lines DL1 and one of the plurality of second data lines DL2.

As shown in FIG. 4, each of the plurality of gate lines GL is configured to provide a gate scanning signal to a plurality of switching thin film transistors in the two adjacent rows of subpixels. For example, each of the plurality of gate lines GL is commonly shared by two adjacent rows of subpixels. Each of the plurality of gate lines GL is configured to provide a gate scanning signal to a plurality of switching thin film transistors in an adjacent pair of one of the plurality of first region 1 and one of the plurality of second region 2. Optionally, the liquid crystal display panel does not include a gate line between a first pair of first region and second region and a second pair of first region and second region.

Optionally, the plurality of first data lines DL1 are configured to provide a plurality of data signals respectively to a plurality of subpixels in the plurality of first regions 1. Optionally, the plurality of second data lines DL2 are configured to provide a plurality of data signals respectively to a plurality of subpixels in the plurality of second regions 2. Optionally, the plurality of first data lines DL1 are configured to provide a plurality of data signals respectively to a plurality of subpixels in the plurality of first regions 1, but the plurality of second data lines DL2 are configured not to provide a plurality of data signals respectively to a plurality of subpixels in the plurality of second regions 2, e.g., the plurality of subpixels in the plurality of second regions 2 are turned off. Optionally, the plurality of second data lines DL2 are configured to provide a plurality of data signals respectively to a plurality of subpixels in the plurality of second regions 2, but the plurality of first data lines DL1 are configured not to provide a plurality of data signals respectively to a plurality of subpixels in the plurality of first regions 1, e.g., the plurality of subpixels in the plurality of first regions 1 are turned off. Optionally, the plurality of first data lines DL1 are configured to provide a plurality of data signals respectively to a plurality of subpixels in the plurality of first regions 1, and at the same time the plurality of second data lines DL2 are configured to provide a plurality of data signals respectively to a plurality of subpixels in the plurality of second regions 2, e.g., the plurality of subpixels in the plurality of first regions 1 and the plurality of second regions 2 are both configured to emit light in a same time interval for image display. Optionally, the plurality of first data lines DL1 are configured to provide a plurality of data signals respectively to a plurality of subpixels in the plurality of first regions 1 for a first time interval, the plurality of second data lines DL2 are configured to provide a plurality of data signals respectively to a plurality of subpixels in the plurality of second regions 2 for a second time interval, the second time interval partially overlapping with the first time interval and being different from the first time interval in duration. Optionally, the second time interval is longer than the first time interval. Optionally, the first time interval is longer than the second time interval.

In some embodiments, the plurality of subpixels in the plurality of first regions 1 and the plurality of second regions 2 are both configured to emit light for image display, e.g., either in a same time interval or in overlapping, different time intervals having different durations, a first subpixel in one of the plurality of first regions 1 and a second subpixel in one of the plurality of second regions 2 may be provided with a same data signal (respectively through a first data line and a second data line), the first subpixel and the second subpixel being adjacent subpixels in a same column along the second direction and both connected to a same gate line. In some embodiments, the plurality of subpixels in the plurality of first regions 1 and the plurality of second regions 2 are both configured to emit light for image display, e.g., either in a same time interval or in overlapping, different time intervals having different durations, a first subpixel in one of the plurality of first regions 1 and a second subpixel in one of the plurality of second regions 2 may be provided with different data signals (respectively through a first data line and a second data line), the first subpixel and the second subpixel being adjacent subpixels in a same column along the second direction and both connected to a same gate line. Optionally, the first subpixel and the second subpixel that are adjacent subpixels in a same column along the second direction and both connected to a same gate line are subpixels of a same color. Optionally, the first subpixel and the second subpixel that are adjacent subpixels in a same column along the second direction and both connected to a same gate line are subpixels of different colors.

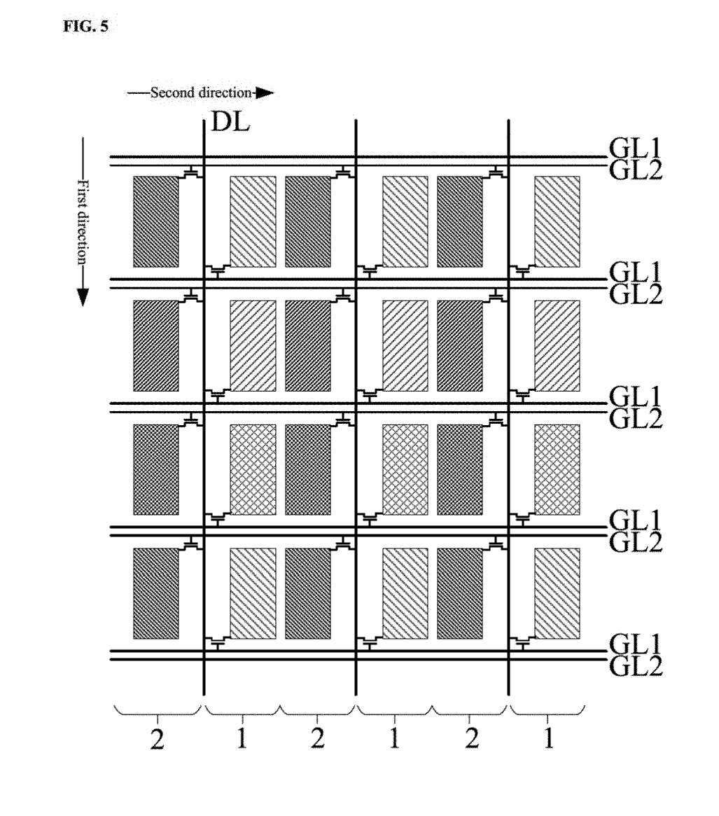

FIG. 5 is a schematic diagram illustrating the structure of a liquid crystal display panel in some embodiments according to the present disclosure. Referring to FIG. 5, the liquid crystal display panel in some embodiments includes a plurality of data lines DL extending substantially along the first direction and a plurality of gate lines extending substantially along the second direction. The plurality of gate lines includes a plurality of first gate lines GL1 and a plurality of second gate lines GL2. Optionally, the plurality of gate lines alternate, along the first direction, between one of the plurality of first gate lines GL1 and one of the plurality of second gate lines GL2. As shown in FIG. 5, between adjacent rows of subpixels along the first direction, the liquid crystal display panel includes one of the plurality of first gate lines GL1 and one of the plurality of second gate lines GL2, e.g., the liquid crystal display panel is a dual gate display panel.

As shown in FIG. 5, each of the plurality of data line DL is configured to provide a plurality of data signals to a plurality of switching thin film transistors in the two adjacent columns of subpixels. For example, each of the plurality of data line DL is commonly shared by two adjacent columns of subpixels. Each of the plurality of data line DL is configured to provide a plurality of data signals to a plurality of switching thin film transistors in an adjacent pair of one of the plurality of first region 1 and one of the plurality of second region 2.

Optionally, the plurality of first gate lines GL1 are configured to provide a plurality of gate scanning signals respectively to a plurality of subpixels in the plurality of first regions 1. For example, each of the plurality of first gate lines GL1 is configured to provide a gate scanning signal to a plurality of subpixels in one of the plurality of first regions 1. Optionally, the plurality of second gate lines GL2 are configured to provide a plurality of gate scanning signals respectively to a plurality of subpixels in the plurality of second regions 2. For example, each of the plurality of second gate lines GL2 is configured to provide a gate scanning signal to a plurality of subpixels in one of the plurality of second regions 2. Optionally, the plurality of first gate lines GL1 are configured to provide a plurality of gate scanning signals respectively to a plurality of subpixels in the plurality of first regions 1, but the plurality of second gate lines GL2 are configured not to provide a plurality of gate scanning signals respectively to a plurality of subpixels in the plurality of second regions 2, e.g., the plurality of subpixels in the plurality of second regions 2 are turned off. Optionally, the plurality of second gate lines GL2 are configured to provide a plurality of gate scanning signals respectively to a plurality of subpixels in the plurality of second regions 2, but the plurality of first gate lines GL1 are configured not to provide a plurality of gate scanning signals respectively to a plurality of subpixels in the plurality of first regions 1, e.g., the plurality of subpixels in the plurality of first regions 1 are turned off. Optionally, the plurality of first gate lines GL1 are configured to provide a plurality of gate scanning signals respectively to a plurality of subpixels in the plurality of first regions 1, and at the same time the plurality of second gate lines GL2 are configured to provide a plurality of gate scanning signals respectively to a plurality of subpixels in the plurality of second regions 2, e.g., the plurality of subpixels in the plurality of first regions 1 and the plurality of second regions 2 are both configured to emit light in a same time interval for image display. Optionally, the plurality of first gate lines GL1 are configured to provide a plurality of gate scanning signals respectively to a plurality of subpixels in the plurality of first regions 1 for a first time interval, the plurality of second gate lines GL2 are configured to provide a plurality of gate scanning signals respectively to a plurality of subpixels in the plurality of second regions 2 for a second time interval, the second time interval partially overlapping with the first time interval and being different from the first time interval in duration. Optionally, the second time interval is longer than the first time interval. Optionally, the first time interval is longer than the second time interval.

In some embodiments, the plurality of subpixels in the plurality of first regions 1 and the plurality of second regions 2 are both configured to emit light for image display, e.g., either in a same time interval or in overlapping, different time intervals having different durations, a first subpixel in one of the plurality of first regions 1 and a second subpixel in one of the plurality of second regions 2 may be provided with a same data signal, the first subpixel and the second subpixel being adjacent subpixels in a same row along the second direction and both connected to a same data line. In some embodiments, the plurality of subpixels in the plurality of first regions 1 and the plurality of second regions 2 are both configured to emit light for image display, e.g., either in a same time interval or in overlapping, different time intervals having different durations, a first subpixel in one of the plurality of first regions 1 and a second subpixel in one of the plurality of second regions 2 may be provided with different data signals, the first subpixel and the second subpixel being adjacent subpixels in a same row along the second direction and both connected to a same data line. Optionally, the first subpixel and the second subpixel that are adjacent subpixels in a same row along the second direction and both connected to a same data line are subpixels of a same color. Optionally, the first subpixel and the second subpixel that are adjacent subpixels in a same row along the second direction and both connected to a same data line are subpixels of different colors.

Accordingly, the present liquid crystal display panel may be configured to operate in multiple display modes. Optionally, the multiple display modes correspond to different brightness levels of the display panel. Depending on the needs and user environments, the liquid crystal display panel may be configured operate in one of a plurality of display modes respectively corresponding to a high brightness level, a medium brightness level, a low brightness level, and any intermediate brightness levels there-between.

The present liquid crystal display panel has enhanced flexibility to be suited for various user needs and working environments. For example, when lower power consumption and a longer battery life are desired (e.g., the user is traveling), the present liquid crystal display panel can be adjusted to a display mode corresponding to the low brightness level or the medium brightness level or an intermediate brightness level. When better user viewing experience and higher display quality are in demand, the present liquid crystal display panel can be adjusted to a display mode corresponding to the high brightness level or an intermediate brightness level.

In some embodiments, the liquid crystal display panel is configured to operate in a first mode. Optionally, in the first mode, a plurality of subpixels in regions corresponding to the plurality of first regions 1 are turned off (e.g., no data signal or no gate scanning signal) and a plurality of subpixels in regions corresponding to the plurality of second regions 2 are configured to emit light for image display. The first mode corresponds to a low brightness level of the display panel.

In some embodiments, the first mode is implemented in a display panel having a structure illustrated in FIG. 4. Optionally, the liquid crystal display panel includes a plurality of gate lines GL and a plurality of data lines. The plurality of data lines extend substantially along the second direction and the plurality of gate lines GL extend substantially along the first direction. Optionally, the plurality of data lines includes a plurality of first data lines DL1 and a plurality of second data lines DL2. Between each pair of adjacent columns of subpixels along the first direction, the liquid crystal display panel includes one of the plurality of first data lines DL1 and one of the plurality of second data lines DL2. Optionally, the plurality of second data lines DL2 are configured to provide a plurality of data signals respectively to a plurality of subpixels in the plurality of second regions 2. A plurality of subpixels in the plurality of first regions 1 are configured to be turned off, e.g., they do not receive a data signal.

In some embodiments, the first mode is implemented in a display panel having a structure illustrated in FIG. 5. Optionally, the liquid crystal display panel includes a plurality of gate lines and a plurality of data lines DL. The plurality of data lines DL extend substantially along the first direction and the plurality of gate lines extend substantially along the second direction. Optionally, the plurality of gate lines includes a plurality of first gate lines GL1 and a plurality of second gate lines GL2. Between each pair of adjacent rows of subpixels along the first direction, the liquid crystal display panel includes one of the plurality of first gate lines GL1 and one of the plurality of second gate lines GL2. Optionally, the plurality of second gate lines GL2 are configured to provide a plurality of gate scanning signals respectively to a plurality of subpixels in the plurality of second regions 2. A plurality of subpixels in the plurality of first regions 1 are configured to be turned off e.g., they do not receive a gate scanning signal.

In some embodiments, the liquid crystal display panel is configured to operate in a second mode. Optionally, in the second mode, a plurality of subpixels in regions corresponding to the plurality of second regions 2 are turned off (e.g., no data signal or no gate scanning signal) and a plurality of subpixels in regions corresponding to the plurality of first regions 1 are configured to emit light for image display. The second mode corresponds to a medium brightness level of the display panel.

In some embodiments, the second mode is implemented in a display panel having a structure illustrated in FIG. 4. Optionally, the liquid crystal display panel includes a plurality of gate lines GL and a plurality of data lines. The plurality of data lines extend substantially along the second direction and the plurality of gate lines GL extend substantially along the first direction. Optionally, the plurality of data lines includes a plurality of first data lines DL1 and a plurality of second data lines DL2. Between each pair of adjacent columns of subpixels along the first direction, the liquid crystal display panel includes one of the plurality of first data lines DL1 and one of the plurality of second data lines DL2. Optionally, the plurality of first data lines DL1 are configured to provide a plurality of data signals respectively to a plurality of subpixels in the plurality of first regions 1. A plurality of subpixels in the plurality of second regions 2 are configured to be turned off e.g., they do not receive a data signal.

In some embodiments, the second mode is implemented in a display panel having a structure illustrated in FIG. 5. Optionally, the liquid crystal display panel includes a plurality of gate lines and a plurality of data lines DL. The plurality of data lines DL extend substantially along the first direction and the plurality of gate lines extend substantially along the second direction. Optionally, the plurality of gate lines includes a plurality of first gate lines GL1 and a plurality of second gate lines GL2. Between each pair of adjacent rows of subpixels along the first direction, the liquid crystal display panel includes one of the plurality of first gate lines GL1 and one of the plurality of second gate lines GL2. Optionally, the plurality of first gate lines GL1 are configured to provide a plurality of gate scanning signals respectively to a plurality of subpixels in the plurality of first regions 1. A plurality of subpixels in the plurality of second regions 2 are configured to be turned off, e.g., they do not receive a gate scanning signal.

In some embodiments, the liquid crystal display panel is configured to operate in a third mode. Optionally, in the third mode, a plurality of subpixels in regions corresponding to the plurality of second regions 2 and a plurality of subpixels in regions corresponding to the plurality of first regions 1 are both configured to emit light for image display. The third mode corresponds to a high brightness level of the display panel.

In some embodiments, the third mode is implemented in a display panel having a structure illustrated in FIG. 4. Optionally, the liquid crystal display panel includes a plurality of gate lines GL and a plurality of data lines. The plurality of data lines extend substantially along the second direction and the plurality of gate lines GL extend substantially along the first direction. Optionally, the plurality of data lines includes a plurality of first data lines DL1 and a plurality of second data lines DL2. Between each pair of adjacent columns of subpixels along the first direction, the liquid crystal display panel includes one of the plurality of first data lines DL1 and one of the plurality of second data lines DL2. Optionally, the plurality of first data lines DL1 are configured to provide a plurality of data signals respectively to a plurality of subpixels in the plurality of first regions 1, and the plurality of second data lines DL2 are configured to provide a plurality of data signals respectively to a plurality of subpixels in the plurality of second regions 2.

In some embodiments, the third mode is implemented in a display panel having a structure illustrated in FIG. 5. Optionally, the liquid crystal display panel includes a plurality of gate lines and a plurality of data lines DL. The plurality of data lines DL extend substantially along the first direction and the plurality of gate lines extend substantially along the second direction. Optionally, the plurality of gate lines includes a plurality of first gate lines GL1 and a plurality of second gate lines GL2. Between each pair of adjacent rows of subpixels along the first direction, the liquid crystal display panel includes one of the plurality of first gate lines GL1 and one of the plurality of second gate lines GL2. Optionally, the plurality of first gate lines GL1 are configured to provide a plurality of gate scanning signals respectively to a plurality of subpixels in the plurality of first regions 1, and the plurality of second gate lines GL2 are configured to provide a plurality of gate scanning signals respectively to a plurality of subpixels in the plurality of second regions 2.

In some embodiments, the liquid crystal display panel is configured to operate in a fourth mode. Optionally, in the fourth mode, a plurality of subpixels in regions corresponding to the plurality of second regions 2 and a plurality of subpixels in regions corresponding to the plurality of first regions 1 are both configured to emit light for image display, but for respectively different time intervals. The fourth mode corresponds to an intermediate brightness level between any two of the high brightness level, the medium brightness level, and the low brightness level. Optionally, in the fourth mode, the plurality of subpixels in regions corresponding to the plurality of first regions 1 are configured to emit light for a first time interval, and the plurality of subpixels in regions corresponding to the plurality of second regions 2 are configured to emit light for a second time interval. The second time interval and the first time interval are overlapping, different time intervals. Optionally, the first time interval is longer than the second time interval. Optionally, the second time interval is longer than the first time interval.

In some embodiments, the fourth mode is implemented in a display panel having a structure illustrated in FIG. 4. Optionally, the liquid crystal display panel includes a plurality of gate lines GL and a plurality of data lines. The plurality of data lines extend substantially along the second direction and the plurality of gate lines GL extend substantially along the first direction. Optionally, the plurality of data lines includes a plurality of first data lines DL1 and a plurality of second data lines DL2. Between each pair of adjacent columns of subpixels along the first direction, the liquid crystal display panel includes one of the plurality of first data lines DL1 and one of the plurality of second data lines DL2. Optionally, the plurality of first data lines DL1 are configured to provide a plurality of data signals respectively to a plurality of subpixels in the plurality of first regions 1 for the first time interval, and the plurality of second data lines DL2 are configured to provide a plurality of data signals respectively to a plurality of subpixels in the plurality of second regions 2 for the second time interval. The second time interval and the first time interval are overlapping, different time intervals. Optionally, the first time interval is longer than the second time interval. Optionally, the second time interval is longer than the first time interval.

In some embodiments, the fourth mode is implemented in a display panel having a structure illustrated in FIG. 5. Optionally, the liquid crystal display panel includes a plurality of gate lines and a plurality of data lines DL. The plurality of data lines DL extend substantially along the first direction and the plurality of gate lines extend substantially along the second direction. Optionally, the plurality of gate lines includes a plurality of first gate lines GL1 and a plurality of second gate lines GL2. Between each pair of adjacent rows of subpixels along the first direction, the liquid crystal display panel includes one of the plurality of first gate lines GL1 and one of the plurality of second gate lines GL2. Optionally, the plurality of first gate lines GL1 are configured to provide a plurality of gate scanning signals respectively to a plurality of subpixels in the plurality of first regions 1 for the first time interval, and the plurality of second gate lines GL2 are configured to provide a plurality of gate scanning signals respectively to a plurality of subpixels in the plurality of second regions 2 for the second time interval. The second time interval and the first time interval are overlapping, different time intervals. Optionally, the first time interval is longer than the second time interval. Optionally, the second time interval is longer than the first time interval.

In some embodiments, the liquid crystal display panel is a fringe field driven liquid crystal display panel, in which the liquid crystal layer is driven by a fringe electric field. Examples of fringe field driven liquid crystal display panel include, but are not limited to, an advanced super-dimensional switching (ADS) liquid crystal display panel, an in-plane switch (IPS) liquid crystal display panel, and a fringe field switching (FFS) liquid crystal display panel.

In another aspect, the present disclosure provides a method of operating a liquid crystal display panel. The present method may be utilized to operate the liquid crystal display panel in multiple display modes, each of which corresponds to a different brightness level of the display panel. For example, the present method may be used to operate the liquid crystal display panel in one of a high brightness level, a medium brightness level, a low brightness level, and any intermediate levels there-between.

In some embodiments, the method includes operating the liquid crystal display panel in a first mode. Optionally, in the first mode, the method includes turning off a plurality of subpixels in regions corresponding to the plurality of first regions 1 (e.g., not providing a data signal or not providing a gate scanning signal) and turning on a plurality of subpixels in regions corresponding to the plurality of second regions 2 to emit light in each frame of image for image display. The first mode corresponds to a low brightness level of the display panel.

In some embodiments, the method includes operating a liquid crystal display panel having a structure illustrated in FIG. 4 in the first mode. Optionally, the liquid crystal display panel includes a plurality of gate lines GL and a plurality of data lines. The plurality of data lines extend substantially along the second direction and the plurality of gate lines GL extend substantially along the first direction. Optionally, the plurality of data lines includes a plurality of first data lines DL1 and a plurality of second data lines DL2. Between each pair of adjacent columns of subpixels along the first direction, the liquid crystal display panel includes one of the plurality of first data lines DL1 and one of the plurality of second data lines DL2. Optionally, the method includes providing a plurality of data signals respectively to a plurality of subpixels in the plurality of second regions 2 through the plurality of second data lines DL2 while turning off a plurality of subpixels in the plurality of first regions 1 (e.g., not providing a data signal).

In some embodiments, the method includes operating a liquid crystal display panel having a structure illustrated in FIG. 5 in the first mode. Optionally, the liquid crystal display panel includes a plurality of gate lines and a plurality of data lines DL. The plurality of data lines DL extend substantially along the first direction and the plurality of gate lines extend substantially along the second direction. Optionally, the plurality of gate lines includes a plurality of first gate lines GL1 and a plurality of second gate lines GL2. Between each pair of adjacent rows of subpixels along the first direction, the liquid crystal display panel includes one of the plurality of first gate lines GL1 and one of the plurality of second gate lines GL2. Optionally, the method includes providing a plurality of gate scanning signals respectively to a plurality of subpixels in the plurality of second regions 2 through the plurality of second gate lines GL2 while turning off a plurality of subpixels in the plurality of first regions 1 (e.g., not providing a gate scanning signal).

In some embodiments, the method includes operating the liquid crystal display panel in a second mode. Optionally, in the second mode, the method includes turning off a plurality of subpixels in regions corresponding to the plurality of second regions 2 (e.g., not providing a data signal or not providing a gate scanning signal) and turning on a plurality of subpixels in regions corresponding to the plurality of first regions 1 to emit light in each frame of image for image display. The second mode corresponds to a medium brightness level of the display panel.

In some embodiments, the method includes operating a liquid crystal display panel having a structure illustrated in FIG. 4 in the second mode. Optionally, the liquid crystal display panel includes a plurality of gate lines GL and a plurality of data lines. The plurality of data lines extend substantially along the second direction and the plurality of gate lines GL extend substantially along the first direction. Optionally, the plurality of data lines includes a plurality of first data lines DL1 and a plurality of second data lines DL2. Between each pair of adjacent columns of subpixels along the first direction, the liquid crystal display panel includes one of the plurality of first data lines DL1 and one of the plurality of second data lines DL2. Optionally, the method includes providing a plurality of data signals respectively to a plurality of subpixels in the plurality of first regions 1 through the plurality of first data lines DL1 while turning off a plurality of subpixels in the plurality of second regions 2 (e.g., not providing a data signal).

In some embodiments, the method includes operating a liquid crystal display panel having a structure illustrated in FIG. 5 in the second mode. Optionally, the liquid crystal display panel includes a plurality of gate lines and a plurality of data lines DL. The plurality of data lines DL extend substantially along the first direction and the plurality of gate lines extend substantially along the second direction. Optionally, the plurality of gate lines includes a plurality of first gate lines GL1 and a plurality of second gate lines GL2. Between each pair of adjacent rows of subpixels along the first direction, the liquid crystal display panel includes one of the plurality of first gate lines GL1 and one of the plurality of second gate lines GL2. Optionally, the method includes providing a plurality of gate scanning signals respectively to a plurality of subpixels in the plurality of first regions 1 through the plurality of first gate lines GL while turning off a plurality of subpixels in the plurality of second regions 2 (e.g., not providing a gate scanning signal).

In some embodiments, the method includes operating the liquid crystal display panel in a third mode. Optionally, in the third mode, the method includes turning on both a plurality of subpixels in regions corresponding to the plurality of first regions 1 and a plurality of subpixels in regions corresponding to the plurality of second regions 2 to emit light in each frame of image for image display. The third mode corresponds to a high brightness level of the display panel.

In some embodiments, the method includes operating a liquid crystal display panel having a structure illustrated in FIG. 4 in the third mode. Optionally, the liquid crystal display panel includes a plurality of gate lines GL and a plurality of data lines. The plurality of data lines extend substantially along the second direction and the plurality of gate lines GL extend substantially along the first direction. Optionally, the plurality of data lines includes a plurality of first data lines DL1 and a plurality of second data lines DL2. Between each pair of adjacent columns of subpixels along the first direction, the liquid crystal display panel includes one of the plurality of first data lines DL1 and one of the plurality of second data lines DL2. Optionally, the method includes providing a plurality of data signals respectively to a plurality of subpixels in the plurality of first regions 1 through the plurality of first data lines DL1, and providing a plurality of data signals respectively to a plurality of subpixels in the plurality of second regions 2 through the plurality of second data lines DL2.

In some embodiments, the method includes operating a liquid crystal display panel having a structure illustrated in FIG. 5 in the third mode. Optionally, the liquid crystal display panel includes a plurality of gate lines and a plurality of data lines DL. The plurality of data lines DL extend substantially along the first direction and the plurality of gate lines extend substantially along the second direction. Optionally, the plurality of gate lines includes a plurality of first gate lines GL1 and a plurality of second gate lines GL2. Between each pair of adjacent rows of subpixels along the first direction, the liquid crystal display panel includes one of the plurality of first gate lines GL1 and one of the plurality of second gate lines GL2. Optionally, the method includes providing a plurality of gate scanning signals respectively to a plurality of subpixels in the plurality of first regions 1 through the plurality of first gate lines GL1, and providing a plurality of gate scanning signals respectively to a plurality of subpixels in the plurality of second regions 2 through the plurality of second gate lines GL2.

In some embodiments, the method includes operating the liquid crystal display panel in a fourth mode. Optionally, in the fourth mode, the method includes turning on the plurality of subpixels in regions corresponding to the plurality of first regions 1 for a first time interval in each frame of image and turning on the plurality of subpixels in regions corresponding to the plurality of second regions 2 for a second time interval in each frame of image. The second time interval and the first time interval are overlapping, different time intervals. Optionally, the first time interval is longer than the second time interval. Optionally, the second time interval is longer than the first time interval. The fourth mode corresponds to an intermediate brightness level between any two of the high brightness level, the medium brightness level, and the low brightness level.

In some embodiments, the method includes operating a liquid crystal display panel having a structure illustrated in FIG. 4 in the fourth mode. Optionally, the liquid crystal display panel includes a plurality of gate lines GL and a plurality of data lines. The plurality of data lines extend substantially along the second direction and the plurality of gate lines GL extend substantially along the first direction. Optionally, the plurality of data lines includes a plurality of first data lines DL1 and a plurality of second data lines DL2. Between each pair of adjacent columns of subpixels along the first direction, the liquid crystal display panel includes one of the plurality of first data lines DL1 and one of the plurality of second data lines DL2. Optionally, the method includes providing a plurality of data signals respectively to a plurality of subpixels in the plurality of first regions 1 through the plurality of first data lines DL1 for the first time interval in each frame of image, and providing a plurality of data signals respectively to a plurality of subpixels in the plurality of second regions 2 through the plurality of second data lines DL2 for the second time interval in each frame of image. The second time interval and the first time interval are overlapping, different time intervals. Optionally, the first time interval is longer than the second time interval. Optionally, the second time interval is longer than the first time interval.

In some embodiments, the method includes operating a liquid crystal display panel having a structure illustrated in FIG. 5 in the fourth mode. Optionally, the liquid crystal display panel includes a plurality of gate lines and a plurality of data lines DL. The plurality of data lines DL extend substantially along the first direction and the plurality of gate lines extend substantially along the second direction. Optionally, the plurality of gate lines includes a plurality of first gate lines GL and a plurality of second gate lines GL2. Between each pair of adjacent rows of subpixels along the first direction, the liquid crystal display panel includes one of the plurality of first gate lines GL1 and one of the plurality of second gate lines GL2. Optionally, the method includes providing a plurality of gate scanning signals respectively to a plurality of subpixels in the plurality of first regions 1 through the plurality of first gate lines GL1 for the first time interval in each frame of image, and providing a plurality of gate scanning signals respectively to a plurality of subpixels in the plurality of second regions 2 through the plurality of second gate lines GL2 for the second time interval in each frame of image. The second time interval and the first time interval are overlapping, different time intervals. Optionally, the first time interval is longer than the second time interval Optionally, the second time interval is longer than the first time interval.

In another aspect, the present disclosure provides a method of fabricating a liquid crystal display panel. In some embodiments, the method includes forming an array substrate, forming a counter substrate facing the array substrate; and forming a liquid crystal layer between the array substrate and the counter substrate. Optionally, the step of forming the array substrate includes forming an array of a plurality of subpixels along a first direction and a second direction. Optionally, the step of forming the liquid crystal layer includes forming a plurality of elongated regions of differing thickness successively along the second direction, each of the plurality of elongated regions substantially along the first direction. Optionally, the step of forming the plurality of elongated regions include forming a plurality of first regions and a plurality of second regions, the plurality of elongated regions are formed to alternate between one of the plurality of first regions and one of the plurality of second regions. Optionally, the liquid crystal layer in each of the plurality of first regions is formed to have a first thickness greater than a second thickness of the liquid crystal layer in each of the plurality of second regions. Optionally, a difference between the first thickness and the second thickness is in a range of approximately 0.2 μm to approximately 0.4 μm.

In some embodiments, the liquid crystal layer is formed to have a higher light transmittance in each of the plurality of first regions than that of the liquid crystal layer in each of the plurality of second regions. Optionally, the liquid crystal layer is formed to have a substantially a same first light transmittance in each of the plurality of first regions, and have substantially a same second light transmittance in each of the plurality of second regions. The first light transmittance is greater than the second light transmittance.

In some embodiments, the liquid crystal display panel is formed to have a first normal distance between the array substrate and the counter substrate in each of the plurality of first regions and a second normal distance between the array substrate and the counter substrate in each of the plurality of second regions, the first normal distance being greater than the second normal distance. Optionally, a difference between the first normal distance and the second normal distance is substantially the same as that between the first thickness and the second thickness.

In some embodiments, the plurality of first regions and the plurality of second regions are formed so that a width of each of the plurality of first regions and the plurality of second regions along the second direction is no greater than twice that of a width along the second direction of each of the plurality of subpixels. Optionally, the plurality of first regions and the plurality of second regions are formed so that a width of each of the plurality of first regions and the plurality of second regions along the second direction is substantially the same as a width along the second direction of each of the plurality of subpixels.

In some embodiments, the method further includes forming a plurality of data lines and forming a plurality of gate lines, the plurality of data lines and the plurality of gate lines are formed crossing over each other thereby defining the array of a plurality of subpixels along the first direction and the second direction. The plurality of data lines are formed to extend substantially along one of the first direction and the second direction. The plurality of gate lines are formed to extend substantially along the other one of the first direction and the second direction.

In some embodiments, the plurality of data lines are formed to extend substantially along the second direction and the plurality of gate lines are formed to extend substantially along the first direction. Optionally, the step of forming the plurality of data lines includes forming a plurality of first data lines and forming a plurality of second data lines. The plurality of data lines are formed so that, between adjacent columns of subpixels along the second direction, the liquid crystal display panel includes one of the plurality of first data lines and one of the plurality of second data lines.

In some embodiments, the plurality of data lines are formed to extend substantially along the first direction and the plurality of gate lines are formed to extend substantially along the second direction. Optionally, the step of forming the plurality of gate lines includes forming a plurality of first gate lines and forming a plurality of second gate lines. The plurality of gate lines are formed so that, between adjacent rows of subpixels along the first direction, the liquid crystal display panel includes one of the plurality of first gate lines and one of the plurality of second gate lines.

In some embodiments, the step of forming the counter substrate includes forming passivation layer on a side of a base substrate proximal to the liquid crystal layer. The passivation layer is formed to have a third thickness in the plurality of first regions and a fourth thickness in the plurality of second regions. The third thickness is less than the fourth thickness. Optionally, a difference between the third thickness and the fourth thickness is substantially the same as that between the first thickness and the second thickness.

In some embodiments, the method of fabricating the liquid crystal display includes forming a fringe field driven liquid crystal display panel, in which the liquid crystal layer is driven by a fringe electric field.

In another aspect, the present disclosure provides a liquid crystal display apparatus having a liquid crystal display panel described herein or fabricated by a method described herein. Examples of appropriate display apparatuses include, but are not limited to, an electronic paper, a mobile phone, a tablet computer, a television, a monitor, a notebook computer, a digital album, a gaming system, etc.

The present liquid crystal display apparatus has enhanced flexibility to be suited for various user needs and working environments. For example, when lower power consumption and a longer battery life are desired (e.g., the user is traveling), the present liquid crystal display apparatus can be adjusted to a display mode corresponding to the low brightness level or the medium brightness level or an intermediate brightness level. When better user viewing experience and higher display quality are in demand, the present liquid crystal display apparatus can be adjusted to a display mode corresponding to the high brightness level or an intermediate brightness level.

The foregoing description of the embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. A liquid crystal display panel, comprising:
an array substrate comprising an array of a plurality of subpixels along a first direction and a second direction;
a counter substrate facing the array substrate; and
a liquid crystal layer between the array substrate and the counter substrate;
wherein the liquid crystal layer comprises a plurality of elongated regions of differing thickness successively along the second direction, each of the plurality of elongated regions substantially along the first direction;
the plurality of elongated regions comprise a plurality of first regions and a plurality of second regions, the plurality of elongated regions alternating between one of the plurality of first regions and one of the plurality of second regions; and
the liquid crystal layer in each of the plurality of first regions has a thickness greater than that in each of the plurality of second regions by approximately 10% to approximately 50%.

2. The liquid crystal display panel of claim 1, wherein light transmittance of the liquid crystal layer in each of the plurality of first regions is higher than that of the liquid crystal layer in each of the plurality of second regions.

3. The liquid crystal display panel of claim 1, wherein the liquid crystal layer in each of the plurality of first regions has a first thickness, and the liquid crystal layer in each of the plurality of second regions has a second thickness, the first thickness being greater than the second thickness.

4. The liquid crystal display panel of claim 1, wherein a width of each of the plurality of first regions and the plurality of second regions along the second direction is substantially the same as a width along the second direction of each of the plurality of subpixels.

5. The liquid crystal display panel of claim 1, further comprising a plurality of data lines and a plurality of gate lines crossing over each other thereby defining the array of a plurality of subpixels along the first direction and the second direction;
wherein the plurality of data lines are substantially along the second direction and the plurality of gate lines are substantially along the first direction;
the plurality of data lines comprises a plurality of first data lines and a plurality of second data lines;
the liquid crystal display panel comprises one of the plurality of first data lines and one of the plurality of second data lines between adjacent columns of subpixels along the first direction;
the plurality of first data lines are configured to provide a plurality of data signals respectively to a plurality of subpixels in the plurality of first regions; and
the plurality of second data lines are configured to provide a plurality of data signals respectively to a plurality of subpixels in the plurality of second regions.

6. The liquid crystal display panel of claim 1, further comprising a plurality of data lines and a plurality of gate lines crossing over each other thereby defining the array of a plurality of subpixels along the first direction and the second direction;
wherein the plurality of data lines are substantially along the first direction and the plurality of gate lines are substantially along the second direction;
the plurality of gate lines comprises a plurality of first gate lines and a plurality of second gate lines;
the liquid crystal display panel comprises one of the plurality of first gate lines and one of the plurality of second gate lines between adjacent rows of subpixels along the first direction;
the plurality of first gate lines are configured to provide a plurality of gate scanning signals respectively to a plurality of subpixels in the plurality of first regions; and
the plurality of second gate lines are configured to provide a plurality of gate scanning signals respectively to a plurality of subpixels in the plurality of second regions.

7. The liquid crystal display panel of claim 1, wherein the counter substrate comprises a base substrate and a passivation layer on a side of the base substrate proximal to the liquid crystal layer;
the passivation layer has a third thickness in the plurality of first regions and a fourth thickness in the plurality of second regions; and
the third thickness is less than the fourth thickness.

8. The liquid crystal display panel of claim 1, wherein a difference between the first thickness and the second thickness is in a range of approximately 0.2 μm to approximately 0.4 μm.

9. The liquid crystal display panel of claim 1, wherein the liquid crystal display panel is a fringe field driven liquid crystal display panel.

10. A liquid crystal display apparatus, comprising a liquid crystal display panel of claim 1.

11. A method of operating a liquid crystal display panel of claim 1, comprising:
turning off a plurality of subpixels in regions corresponding to the plurality of first regions; and
turning on a plurality of subpixels in regions corresponding to the plurality of second regions to emit light in each frame of image for image display.

12. The method of claim 11, wherein the plurality of data lines are substantially along the second direction and the plurality of gate lines are substantially along the first direction;
the plurality of data lines comprises a plurality of first data lines and a plurality of second data lines;
the liquid crystal display panel comprises one of the plurality of first data lines and one of the plurality of second data lines between adjacent columns of subpixels along the second direction; and
the method further comprises providing a plurality of data signals respectively to a plurality of subpixels in the plurality of second regions through the plurality of second data lines; and
turning off a plurality of subpixels in the plurality of first regions.

13. The method of claim 11, wherein the plurality of data lines are substantially along the first direction and the plurality of gate lines are substantially along the second direction;
the plurality of gate lines comprises a plurality of first gate lines and a plurality of second gate lines;
the liquid crystal display panel comprises one of the plurality of first gate lines and one of the plurality of second gate lines between adjacent rows of subpixels along the first direction; and
the method further comprises providing a plurality of gate scanning signals respectively to a plurality of subpixels in the plurality of second regions through the plurality of second gate lines; and
turning off a plurality of subpixels in the plurality of first regions.

14. A method of operating a liquid crystal display panel of claim 1, comprising:
turning off a plurality of subpixels in regions corresponding to the plurality of second regions; and
turning on a plurality of subpixels in regions corresponding to the plurality of first regions to emit light in each frame of image for image display.

15. The method of claim 14, wherein the plurality of data lines are substantially along the second direction and the plurality of gate lines are substantially along the first direction;
the plurality of data lines comprises a plurality of first data lines and a plurality of second data lines;
the liquid crystal display panel comprises one of the plurality of first data lines and one of the plurality of second data lines between adjacent columns of subpixels along the second direction; and
the method further comprises providing a plurality of data signals respectively to a plurality of subpixels in the plurality of first regions through the plurality of first data lines; and
turning off a plurality of subpixels in the plurality of second regions.

16. The method of claim 14, wherein the plurality of data lines are substantially along the first direction and the plurality of gate lines are substantially along the second direction;
the plurality of gate lines comprises a plurality of first gate lines and a plurality of second gate lines;
the liquid crystal display panel comprises one of the plurality of first gate lines and one of the plurality of second gate lines between adjacent rows of subpixels along the first direction; and
the method further comprises providing a plurality of gate scanning signals respectively to a plurality of subpixels in the plurality of first regions through the plurality of first gate lines; and
turning off a plurality of subpixels in the plurality of second regions.

17. A method of operating a liquid crystal display panel of claim 1, comprising turning on both a plurality of subpixels in regions corresponding to the plurality of first regions and a plurality of subpixels in regions corresponding to the plurality of second regions to emit light in each frame of image for image display.

18. The method of claim 17, wherein the plurality of data lines are substantially along the second direction and the plurality of gate lines are substantially along the first direction;
the plurality of data lines comprises a plurality of first data lines and a plurality of second data lines;
the liquid crystal display panel comprises one of the plurality of first data lines and one of the plurality of second data lines between adjacent columns of subpixels along the second direction; and
the method further comprises providing a plurality of data signals respectively to a plurality of subpixels in the plurality of first regions through the plurality of first data lines, and
providing a plurality of data signals respectively to a plurality of subpixels in the plurality of second regions through the plurality of second data lines.

19. The method of claim 17, wherein the plurality of data lines are substantially along the first direction and the plurality of gate lines are substantially along the second direction;
the plurality of gate lines comprises a plurality of first gate lines and a plurality of second gate lines;
the liquid crystal display panel comprises one of the plurality of first gate lines and one of the plurality of second gate lines between adjacent rows of subpixels along the first direction;
the method further comprises providing a plurality of gate scanning signals respectively to a plurality of subpixels in the plurality of first regions through the plurality of first gate lines, and
providing a plurality of gate scanning signals respectively to a plurality of subpixels in the plurality of second regions through the plurality of second gate lines.

20. A method of operating a liquid crystal display panel of claim 1, comprising turning on the plurality of subpixels in regions corresponding to the plurality of first regions for a first time interval in each frame of image; and
turning on the plurality of subpixels in regions corresponding to the plurality of second regions for a second time interval in each frame of image, the second time interval being different from the first time interval.
